(19) United States
(12) Patent Application Publication
(10) Pub. No.: US 2012/0028170 A1
(43) Pub. Date: Feb. 2, 2012

(54) ELECTROCATALYST OF CARBON NANOTUBES ENCAPSULATING PLATINUM GROUP METAL NANOPARTICLES FOR FUEL CELLS

(75) Inventors: Nahid Sarlak, Tehran (IR); Akram Dourani, Tehran (IR)

(73) Assignees: Nahid Sarlak, Tehran (IR); Engineering Research Institute of the Iranian Space Agency, Tehran (IR); Akram Dourani, Tehran (IR)

(21) Appl. No.: 13/156,452

(22) Filed: Jun. 9, 2011

(51) Int. Cl. H01M 4/92; B05D 1/06

(52) U.S. Cl. 429/524; 427/485

(57) ABSTRACT

A fuel cell electrode and a method for forming the fuel cell electrode are disclosed. Initially, carbon nanotubes grafted with poly(citric acid) encapsulating platinum group metal nanoparticles are synthesized. The carbon nanotubes grafted with poly(citric acid) encapsulating platinum group metal nanoparticles are then electrospray deposited on an electrode of a fuel cell.

### SPONSORSHIP STATEMENT

This application has been sponsored by the Iranian Nanotechnology Initiative Council, the University of Lorestan, and the Engineering Research Institute of the Iranian Space Agency.

### TECHNICAL FIELD

This application generally relates to electrocatalysts, and more particularly relates to an electrocatalyst of carbon nanotubes encapsulating platinum group metal nanoparticles for fuel cells.

### BACKGROUND

Interest in direct methanol fuel cells as power sources for portable electronic devices has been increasing in recent years due, in part, to the low operating temperature of the fuel cells and the high energy density of methanol. The overall performance of direct methanol fuel cells depends on several factors, such as the activity of the electrocatalyst used in the fuel cells. As such, improving the performance of methanol electro-oxidation reaction catalysts is vital in increasing the efficiency of direct methanol fuel cells.

Recently, a variety of nanomaterials, such as carbon nanotubes (hereinafter “CNTs”), have been tested for use in electrocatalysts due to their distinctive physical and chemical characteristics. However, despite the distinctive characteristics of CNTs, their insolubility and limited conductivity hinder their use as electrocatalysts. As such, a need to overcome the limitations of CNTs for use in electrocatalysts to improve overall fuel cell performance exists.

### SUMMARY

A fuel cell electrode and a method for forming the fuel cell electrode are disclosed. Initially, carbon nanotubes grafted with poly(citric acid) encapsulating platinum group metal nanoparticles are synthesized. The carbon nanotubes grafted with poly(citric acid) encapsulating platinum group metal nanoparticles are then electrospray deposited on an electrode of a fuel cell. The fuel cell can be a direct methanol fuel cell and the electrode can be an anode of the direct methanol fuel cell.

In some implementations, the carbon nanotubes grafted with poly(citric acid) encapsulating platinum group metal nanoparticles can be synthesized by oxidizing carbon nanotubes. Next, the oxidized carbon nanotubes and monohydrated citric acid can be mixed to synthesize carbon nanotubes grafted with poly(citric acid). The carbon nanotubes grafted with poly(citric acid) can then be mixed with one or more sources of platinum group metal ions to synthesize the carbon nanotubes grafted with poly(citric acid) encapsulating platinum group metal nanoparticles.

In some implementations, the carbon nanotubes can be oxidized by mixing the carbon nanotubes with nitric acid and sulfuric acid in a first mixture. The ratio of the nitric acid to the sulfuric acid in the first mixture can be 1 to 3. The carbon nanotubes can be multi-walled carbon nanotubes.

In some implementations, the platinum group metal nanoparticles can be platinum nanoparticles and the source of platinum group metal ions can be one or more of chloroplatinic acid, platinum oxide, platinum chloride, and platinum acetylacetonate. In some implementations, the platinum group metal nanoparticles can be palladium nanoparticles and the source of palladium group metal ions can be one or more of palladium chloride, palladium nitrate, palladium sulfate, and palladium acetylacetonate. In some implementations, the platinum group metal nanoparticles can be both platinum and palladium nanoparticles, where the ratio of platinum nanoparticles to palladium nanoparticles can be 2:1.

In some implementations, the carbon nanotubes grafted with poly(citric acid) encapsulating platinum group metal nanoparticles can be electrospray deposited on the electrode of the fuel cell at a flow rate greater than or equal to 600 μL/min, at an electric field potential greater than or equal to 18 kV, and/or in an interlaced manner.

Another method for forming a direct methanol fuel cell anode is also disclosed. Initially, carbon nanotubes are oxidized and then mixed with monohydrated citric acid to synthesize carbon nanotubes grafted with poly(citric acid). Next, the carbon nanotubes grafted with poly(citric acid) are mixed with chloroplatinic acid, palladium chloride, and sodium borohydride to synthesize carbon nanotubes grafted with poly(citric acid) encapsulating platinum and palladium nanoparticles. The ratio of platinum nanoparticles to palladium nanoparticles can be greater than or equal to 2:1. Finally, the carbon nanotubes grafted with poly(citric acid) encapsulating platinum and palladium nanoparticles are electrospray deposited on an anode of a direct methanol fuel cell. In some implementations, the amount of the chloroplatinic acid mixed with the carbon nanotubes grafted with poly(citric acid) can be twice that of the palladium chloride.

Details of one or more implementations and/or embodiments of the electrocatalyst of CNTs encapsulating platinum group metal nanoparticles for fuel cells are set forth in the accompanying drawings and the description below. Other aspects that can be implemented will be apparent from the description and drawings, and from the claims.

### BRIEF DESCRIPTION OF DRAWINGS

FIG. 1 illustrates an example of a method for synthesizing polymerized CNTs encapsulating platinum group metal nanoparticles and coating an electrode of a fuel cell with the polymerized CNTs encapsulating platinum group metal nanoparticles.

FIG. 2 illustrates a Fourier transform infrared spectrum of oxidized multi-walled CNTs.

FIG. 3 illustrates a Fourier transform infrared spectrum of multi-walled CNTs grafted with poly(citric acid).

FIGS. 4a-b illustrate transmission electron micrographs of multi-walled CNTs grafted with poly(citric acid) encapsulating platinum nanoparticles.

FIGS. 5a-b illustrate transmission electron micrographs of multi-walled CNTs grafted with poly(citric acid) encapsulating palladium nanoparticles.

FIGS. 6a-b illustrate transmission electron micrographs of multi-walled CNTs grafted with poly(citric acid) encapsulating platinum and palladium nanoparticles.

FIG. 7 illustrates an example electrospray deposition apparatus for depositing an electrocatalyst on an electrode.

FIGS. 8a-b illustrate scanning electron micrographs of multi-walled CNTs grafted with poly(citric acid) encapsulating platinum nanoparticles deposited on an aluminum electrode.

FIGS. 9a-b illustrate scanning electron micrographs of multi-walled CNTs grafted with poly(citric acid) encapsulating palladium nanoparticles deposited on an aluminum electrode.

FIGS. 10a-b illustrate scanning electron micrographs of multi-walled CNTs grafted with poly(citric acid) encapsulating platinum and palladium nanoparticles deposited on an aluminum electrode.

Like reference symbols indicate like elements throughout the specification and drawings.

### DETAILED DESCRIPTION

CNTs encapsulating platinum group metal nanoparticles can be used as electrocatalysts for fuel cells such as, for example, direct-methanol fuel cells (hereinafter “DMFCs”). Following polymerization with poly(citric acid), the CNTs become water soluble and can also trap platinum group metal nanoparticles, such as, for example, platinum (Pt) and/or palladium (Pd) ions. Thereafter, the polymerized CNTs encapsulating platinum group metal nanoparticles can be deposited on a film and/or electrode by electrospray deposition. Such a novel electrocatalyst has higher electrocatalytic activity and enhanced carbon monoxide tolerance in fuel cells, as described in greater detail below.

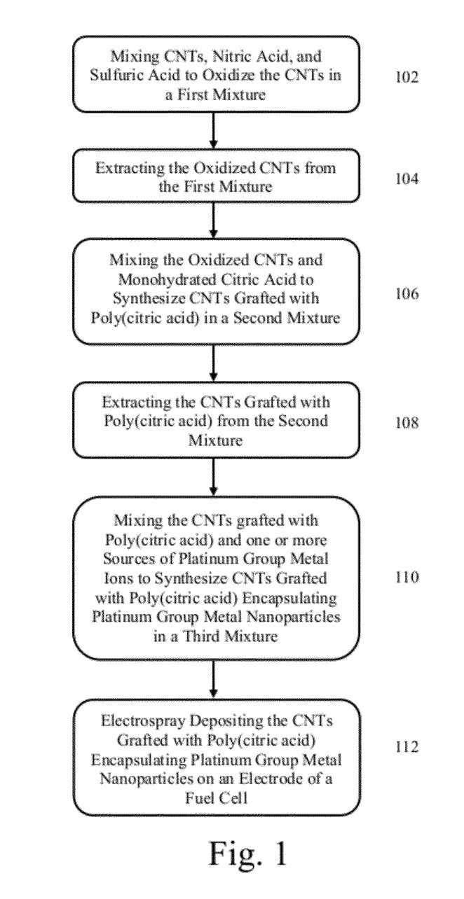

Referring to FIG. 1, a method for synthesizing polymerized CNTs encapsulating platinum group metal nanoparticles and coating an electrode of a fuel cell with the polymerized CNTs encapsulating platinum group metal nanoparticles is illustrated. Initially, CNTs, nitric acid (HNO₃), and sulfuric acid (H₂SO₄) are mixed to oxidize the CNTs in a first mixture (step 102). The CNTs can be, for example, single-walled CNTs (hereinafter “SWCNTs”) and/or multi-walled CNTs (hereinafter “MWCNTs”). MWCNTs can have 3 to 15 walls, an outer diameter of 10 to 40 nm, a length of 1 to 10 μm, and a specific surface area of 40 to 300 m²/g. In some implementations, the MWCNTs can be synthesized over nanoporous Co—Mo/MgO by a chemical vapor deposition method at a temperature of about 900° C.

The nitric acid and the sulfuric acid can be mixed at, for example, a 1:3 ratio. For example, in some implementations, 2 g of MWCNTs can be mixed with 40 mL of a nitric and sulfuric acid solution including about 10 mL of nitric acid and about 30 mL of sulfuric acid to oxidize the MWCNTs in the first mixture.

The mixture of CNTs, nitric acid, and sulfuric acid can be mixed in a reaction flask and refluxed for about 24 hours at 120° C. The resultant first mixture can then be cooled, diluted with distilled water, and filtered. The filtered product can then be washed with distilled water.

Next, the oxidized CNTs are extracted from the first mixture (step 104). The filtrate resulting from step 102 can, for example, be dried in a vacuum oven for about 24 hours at 40° C. to extract the oxidized CNTs.

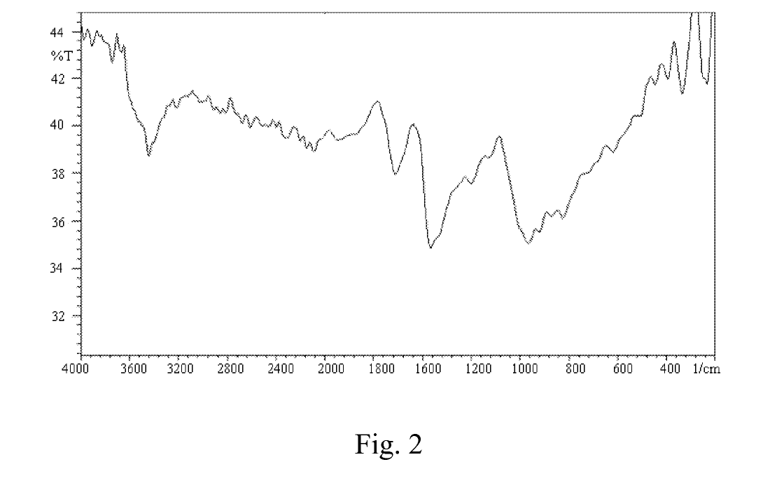

The Fourier transform infrared (hereinafter “FTIR”) spectrum of oxidized MWCNTs is illustrated in FIG. 2. The FTIR spectrum indicates that the treatment of nitric acid and sulfuric acid introduces functional groups onto the surface of the oxidized MWCNTs. The existence of hydroxyl groups, carbonyl groups, and carboxyl groups at 3444, 1700, and 1550 cm⁻¹, respectively, is shown in FIG. 2.

The oxidized CNTs and monohydrated citric acid are then mixed to synthesize CNTs grafted with poly(citric acid) (hereinafter “CNTs-g-PCA”) in a second mixture (step 106). Poly(citric acid) is a highly functional polymer with a large number of hydroxyl functional groups that confer a high loading capacity to the CNTs. In addition, the CNTs-g-PCA are soluble both in water and in organic solvents due to their attached functional groups. Moreover, due to the relatively low cost of citric acid, polymerization of CNTs with poly(citric acid) is economically advantageous relative to other forms of polymerization.

In some implementations, 0.05 g of oxidized CNTs and 2.5 g of monohydrated citric acid can be added to a polymerization ampoule equipped with a magnetic stirrer and a vacuum inlet. The second mixture can be heated to 120° C. and stirred for 30 minutes. Then, the temperature of the second mixture can be gradually increased to 140° C. over a time period of one hour while a dynamic vacuum is operated at proper intervals to remove the water from the second mixture. Following removal of the water by the dynamic vacuum, the reaction temperature can be raised to 160° C. and polymerization can continue at this temperature for about one and a half hours. The resulting product can then be cooled and dissolved in tetrahydrofuran.

Next, the CNTs-g-PCA are extracted from the second mixture (step 108). In some implementations, the CNTs-g-PCA can be purified by precipitating the second mixture in cyclohexane to extract the free citric acid, leaving the purified CNTs-g-PCA in tetrahydrofuran.

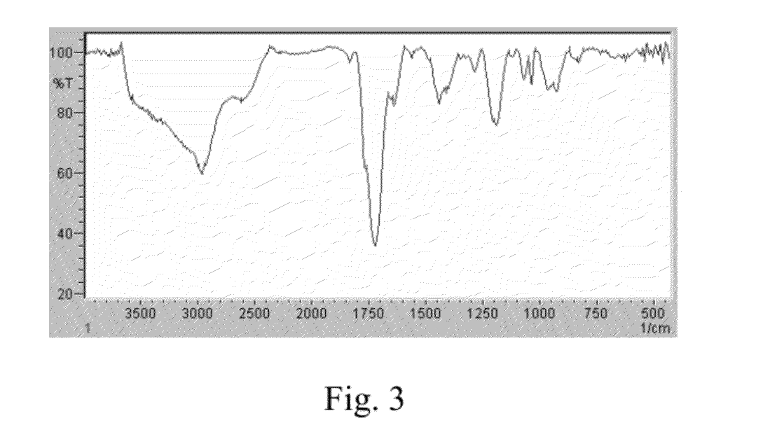

Referring to FIG. 3, the FTIR spectra of MWCNTs-g-PCA is illustrated. A broad absorbance band between 3600 cm⁻¹ and 2700 cm⁻¹ appears for the hydroxyl functional groups of the MWCNTs-g-PCA and the two absorbance bands of the carbonyl groups of citric acid appear at 1718 cm⁻¹ and 1637 cm⁻¹. The absorbance band of the carbon-to-carbon double bonds of the MWCNTs appears at 1500 cm⁻¹.

The CNTs-g-PCA and one or more sources of platinum group metal ions are then mixed with water to synthesize CNTs-g-PCA encapsulating platinum group metal nanoparticles (hereinafter “CNTs-g-PCA-M”) in a third mixture (step 110). The platinum group metal ions can be ions of one or more of ruthenium (Ru), rhodium (Rh), palladium (Pd), osmium (Os), iridium (Ir), and platinum (Pt).

In some implementations, if the metal to be encapsulated is platinum, the source of the platinum ions can be, for example, chloroplatinic acid (hexachloroplatinic acid; H₂PtCl₆.(H₂O)₆), platinum oxide (PtO₂), platinum chloride (PtCl₂), and/or platinum acetylacetonate (Pt(CH₃COCHCOCH₃)₂). For example, 0.2 g of CNTs-g-PCA and 0.26 g to 0.52 g of chloroplatinic acid can be mixed with water and sonicated for about 15 minutes to disperse the platinum ions in the polymeric shells of the CNTs-g-PCA. The third mixture can then be stirred at room temperature for one to four hours. Finally, about 0.05 ml of 0.01 M aqueous sodium borohydride (sodium tetrahydridoborate; NaBH₄) can be added to the third solution as a reducing agent and stirred at room temperature for about one hour to synthesize the CNTs-g-PCA encapsulating platinum nanoparticles (hereinafter “CNTs-g-PCA-Pt”).

In some implementations, if the metal to be encapsulated is palladium, the source of the palladium ions can be, for example, palladium chloride (palladium dichloride; PdCl₂), palladium nitrate (PdN₂O₆), palladium sulfate (PdSO₄), and/or palladium acetylacetonate (Pd(CH₃COCHCOCH₃)₂). For example, 0.2 g of CNTs-g-PCA and 0.26 g of palladium chloride can be mixed with water and sonicated for about 20 minutes to disperse the palladium ions in the polymeric shells of the CNTs-g-PCA. The third mixture can then be stirred at room temperature for five to ten hours. Finally, about 0.10 ml of 0.01 M aqueous sodium borohydride can be added to the third solution as a reducing agent and stirred at room temperature for about one hour to synthesize the CNTs-g-PCA encapsulating palladium nanoparticles (hereinafter “CNTs-g-PCA-Pd”).

In some implementations, if both platinum and palladium nanoparticles are to be encapsulated, the process for encapsulating platinum ions in the polymeric shells of the CNTs-g-PCA described above can first be performed, i.e., the CNTs-g-PCA and chloroplatinic acid can be mixed with water, and then mixed with aqueous sodium borohydride. Next, the process for encapsulating palladium ions can be performed by mixing the third mixture including the CNTs-g-PCA-Pt with palladium chloride and then aqueous sodium borohydride, as described above, to synthesize CNTs-g-PCA encapsulating platinum and palladium nanoparticles (hereinafter “CNTs-g-PCA-Pt&Pd”).

In some implementations, if more platinum nanoparticles are to be encapsulated in the polymeric shells of the CNTs-g-PCA, the amount of the source of platinum ions added to the third mixture can be increased. For example, if twice the number of platinum ions are to be encapsulated relative to the number of palladium ions, then twice the amount of the source of the platinum ions can be added to the third mixture relative to the amount of the source of the palladium ions added. In one example, 0.2 g of CNTs-g-PCA and 0.52 g of chloroplatinic acid can be mixed with water and then mixed with 0.05 ml of 0.01 M aqueous sodium borohydride to disperse the platinum ions in the polymeric shells of the CNTs-g-PCA. Next, 0.26 g of palladium chloride can be added to the third mixture followed by 0.10 ml of 0.01 M aqueous sodium borohydride to disperse the palladium ions in the polymeric shells of the CNTs-g-PCA-Pt, resulting in CNTs-g-PCA-Pt&Pd (2:1) having twice as many platinum ions as palladium ions. If 0.26 g of chloroplatinic acid was added to the third mixture, the ratio of platinum ions to palladium ions in the polymeric shells of the CNTs-g-PCA would be 1:1.

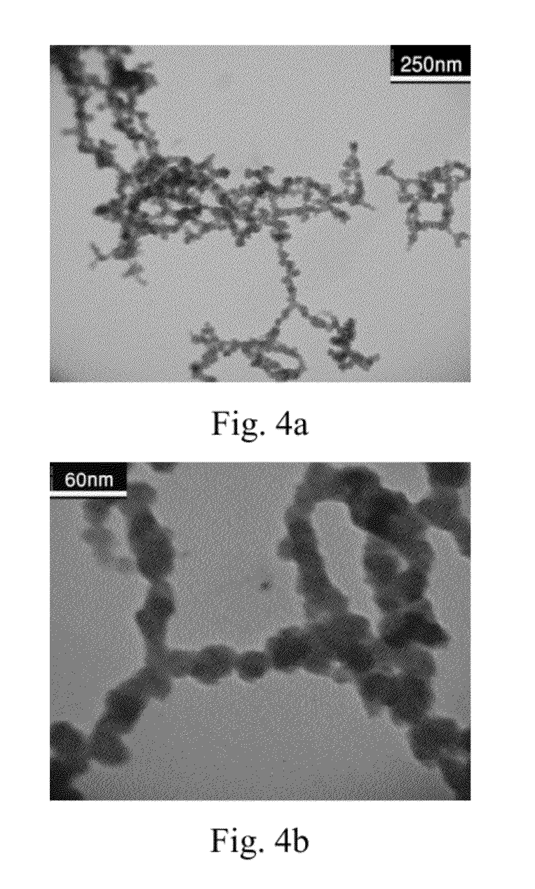

FIGS. 4a-b illustrate transmission electron microscopy (hereinafter “TEM”) images of MWCNTs-g-PCA-Pt synthesized according to the method disclosed above. FIGS. 4a-b show the presence of platinum nanoparticles homogenously distributed in the MWCNTs-g-PCA-Pt at resolutions of 250 nanometers and 60 nanometers, respectively.

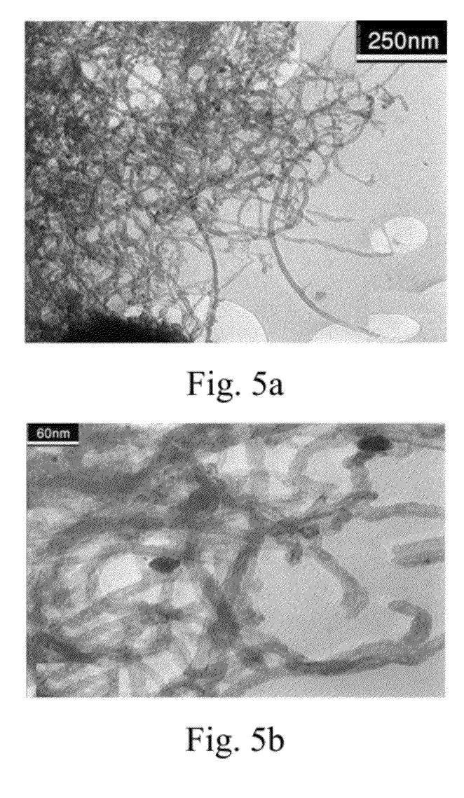

FIGS. 5a-b illustrate TEM images of MWCNTs-g-PCA-Pd prepared according to the method disclosed above. FIGS. 5a-b show the presence of palladium nanoparticles homogenously distributed in the MWCNTs-g-PCA-Pd at resolutions of 250 nanometers and 60 nanometers, respectively.

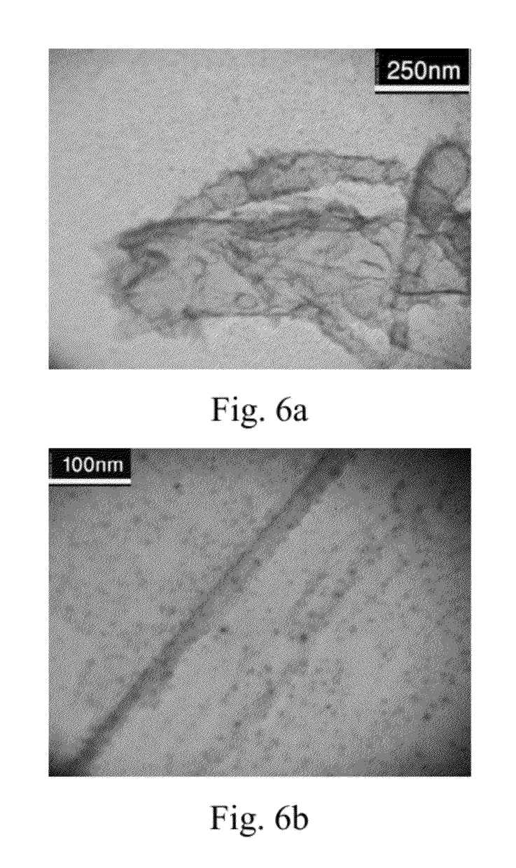

FIGS. 6a-b illustrate TEM images of MWCNTs-g-PCA-Pt&Pd prepared according to the method disclosed above. FIGS. 6a-b show the presence of platinum and palladium nanoparticles homogenously distributed in the MWCNTs-g-PCA-Pt&Pd at resolutions of 250 nanometers and 100 nanometers, respectively.

Once the CNTs-g-PCA-M have been synthesized, they can be electrospray deposited on an electrode of a fuel cell (step 112). In some implementations, if the fuel cell is a DMFC, CNTs-g-PCA-M can be electrospray deposited on the anode of the DMFC. The anode of the DMFC can be made of any material, such as, for example, aluminum (Al). The method of electrospray deposition provides many advantages, such as, the ability to control the thickness, morphology, and uniformity of the electrocatalyst layer on the electrode by manipulating the concentration of solution being sprayed, the flow rate of the electrospraying device, and the magnitude of the electric field generated by the electrospraying device. Moreover, the electrospray deposition can be performed at room temperature. The thickness of the CNTs-g-PCA-M electrocatalyst layer can range from 10 nm to 500 μm.

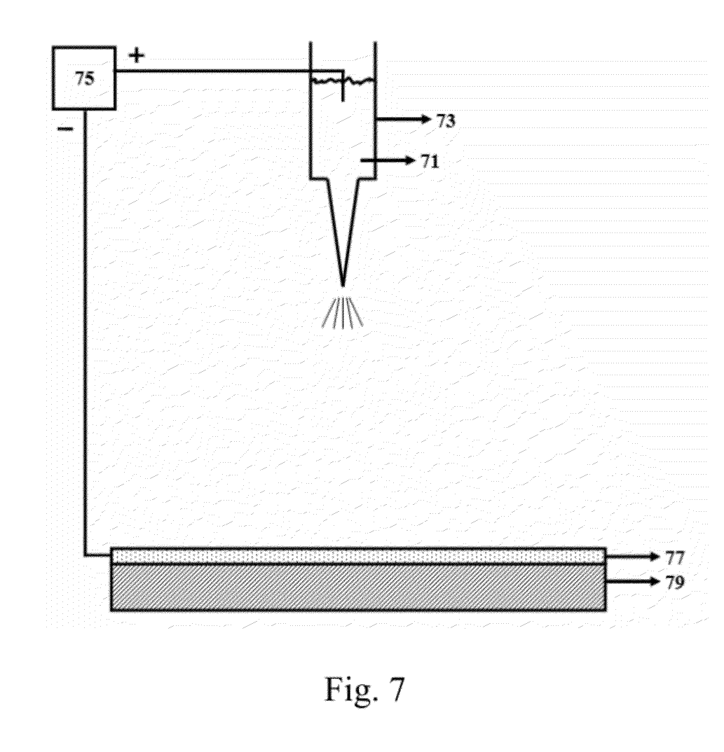

In some implementations, referring to the example electrospray deposition apparatus of FIG. 7, the third mixture 71 including the CNTs-g-PCA-M electrocatalyst is poured into a spraying capillary 73. The spraying capillary 73 can be a conductive needle, a syringe, or any other capillary capable of spraying a solution. The spraying capillary 73 can be connected to a pumping mechanism (not shown) that applies force to the third mixture 71 so that it is sprayed out of the spraying capillary 73 at a desired and constant flow rate. For example, a relatively high flow rate greater than 500 μL/min and, preferably, 600 μL/min, can be used to electrospray the third mixture 71.

A power source 75 can apply a positive voltage to the third mixture 71 and/or spraying capillary 73 and a ground or negative voltage to the substrate 77. As such, an electric field is created between the spraying capillary 73 and the substrate 77 that results in a positively charged mist sprayed towards the substrate 77, as illustrated in FIG. 7. For example, the positive voltage generated by the power source 75 can be about 18 kV to overcome the surface tension of the viscous third mixture 71. The distance between the tip of the spraying capillary 73 and the substrate 77 can range from eight to ten cm.

The charged mists can be applied to the substrate 77, which can be an electrode of a fuel cell. In some implementations, for example, the substrate 77 can be made of a metal, such as, for example, aluminum (Al), copper (Cu), and/or stainless steel, as an anode of a DMFC. The substrate 77 is placed on a motorized x-y stage 79, which moves in an interlaced manner so that part of, or an entirety, of the substrate 77 can be coated with the CNTs-g-PCA-M electrocatalyst. In the interlaced movement, sequential rows and/or columns of the substrate 77 can be sprayed by the charged mists. The motorized x-y stage 79 can be controlled by, for example, one or more stepper motors. Finally, a layer of the CNTs-g-PCA-M electrocatalyst is deposited on the substrate 77.

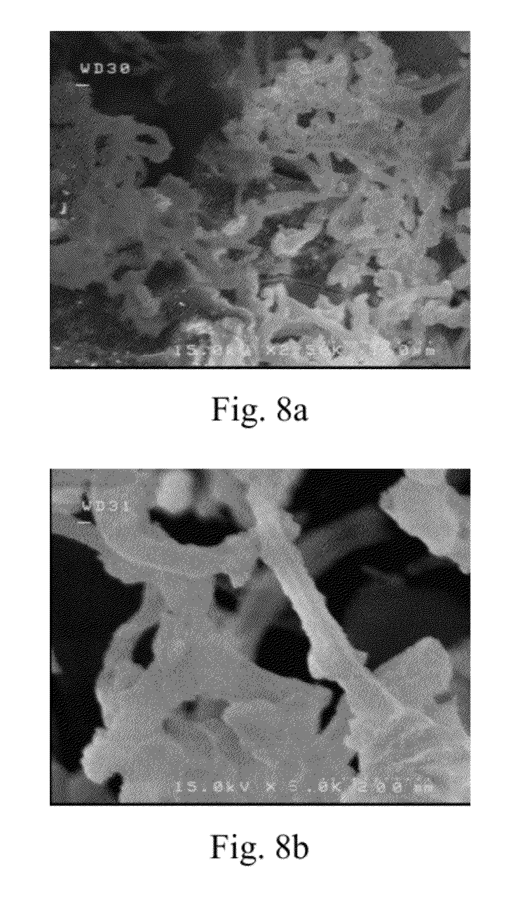

FIGS. 8a-b illustrate scanning electron microscopy (hereinafter “SEM”) images of MWCNTs-g-PCA-Pt electrocatalyst deposited on an aluminum electrode according to the method disclosed above captured at 15 kV. FIGS. 8a-b show the presence of well-entangled and interconnected porous nanotube structures including platinum nanoparticles adhered to the surface of the aluminum electrode at magnifications of 2,500 times and 6,000 times, respectively.

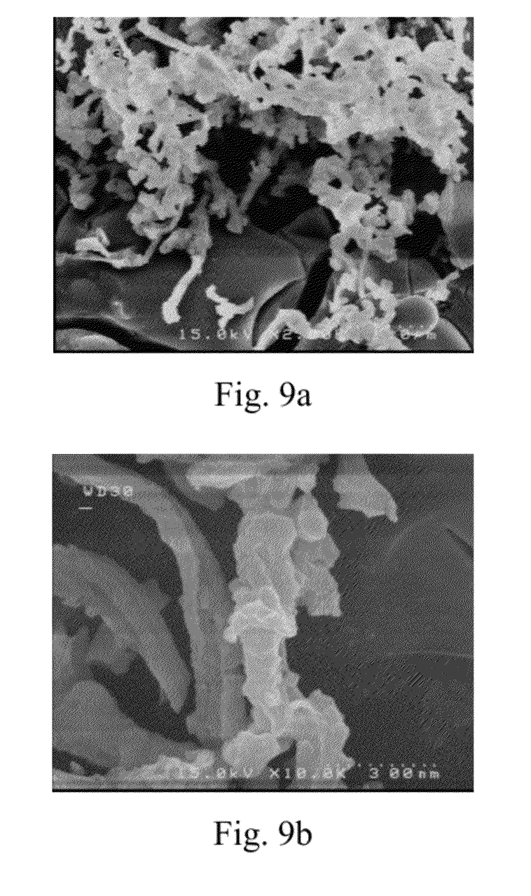

FIGS. 9a-b illustrate SEM images of MWCNTs-g-PCA-Pd electrocatalyst deposited on an aluminum electrode according to the method disclosed above captured at 15 kV. FIGS. 9a-b show the presence of well-entangled and interconnected porous nanotube structures including palladium nanoparticles adhered to the surface of the aluminum electrode at magnifications of 2,000 times and 10,000 times, respectively.

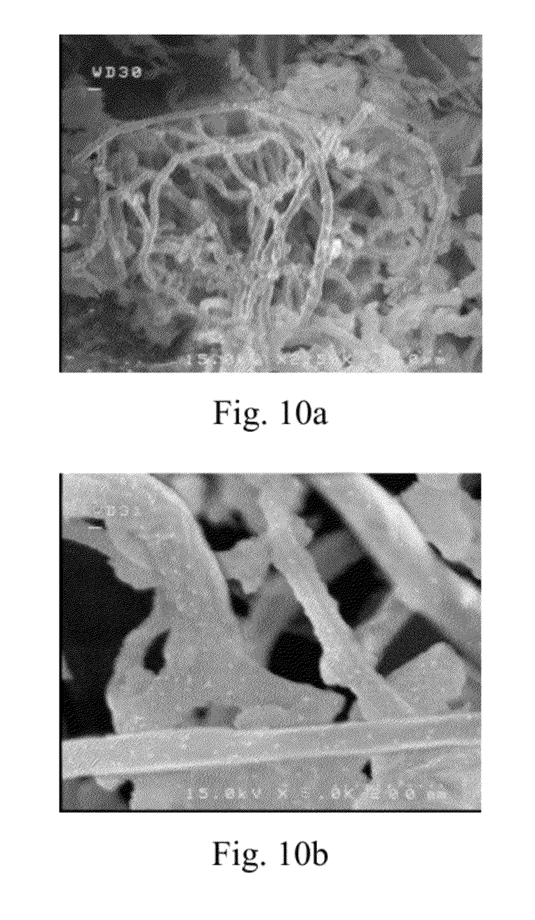

FIGS. 10a-b illustrate SEM images of MWCNTs-g-PCA-Pt&Pd electrocatalyst deposited on an aluminum electrode according to the method disclosed above captured at 15 kV. FIGS. 10a-b show the presence of well-entangled and interconnected porous nanotube structures including platinum and palladium nanoparticles adhered to the surface of the aluminum electrode at magnifications of 2,500 times and 6,000 times, respectively.

To produce electricity, some DMFCs rely on the oxidation of methanol (CH₃OH) in water (H₂O) in the presence of a platinum (Pt) catalyst on an anode to form carbon dioxide (CO₂), according to the following two-step electrochemical equations:

Pt+CH₃OH→Pt—CO_{ads}+4H⁺+4e⁻ (1), and

Pt—CO_{ads}+H₂O→Pt+CO₂+2H⁺+2e⁻ (2).

The overall oxidation of methanol at the anode, as a combination of electrochemical EQS. 1-2, can be expressed by the following electrochemical equation:

CH₃OH+H₂O→CO₂+6H⁺+6e⁻ (3).

The protons (H⁺) released at the anode are transported across a proton exchange membrane to the cathode of the DMFC, where they react with oxygen to produce water, according to the following electrochemical equation:

$$\frac{3}{2} {O}_{2} + 6 {H}^{+} + 6 {e}^{-} -> 3 {H}_{2} O . \qquad ( 4 )$$

As such, water is consumed at the anode during oxidation and is produced at the cathode. The released electrons (e⁻) are not allowed through the proton exchange membrane and instead are transported through an external circuit from the anode to the cathode, thereby powering connected devices.

As shown in electrochemical EQ. 1, carbon monoxide bonds with the platinum electrocatalyst during methanol oxidation, resulting in a decrease of methanol-oxidation activity of the electrocatalyst. However, water can oxidize the bonded carbon monoxide to carbon dioxide, as shown in electrochemical EQ. 2, freeing two protons and two electrons.

In order to test the effectiveness of the various CNTs-g-PCA-M electrocatalysts of the present application, cyclic voltammetry of DMFCs using the various CNTs-g-PCA-M electrocatalysts were evaluated using an Autolab Model No. 30 PGSTAT at room temperature. The DMFCs had a conventional three-electrode cell structure with an anode of aluminum coated with an electrocatalyst, a cathode of platinum, and reference electrodes of saturated calomel (hereinafter “SCE”). The aqueous electrolyte used was 0.5M methanol and 0.5M sulfuric acid (H₂SO₄). The 0.5M sulfuric acid was deaerated with nitrogen prior to use in the DMFCs to eliminate the parasitic influence of oxygen. The applied potential range for the cyclic voltammetry was between 0 V and 1.0 V at a scanning rate of 50 mV/s.

Four CNTs-g-PCA-M electrocatalysts were tested by cyclic voltammetry: MWCNTs-g-PCA-Pd, MWCNTs-g-PCA-Pt, MWCNTs-g-PCA-Pt&Pd (1:1) where the ratio of platinum nanoparticles to palladium nanoparticles was 1:1, and MWCNTs-g-PCA-Pt&Pd (2:1) where the ratio of platinum nanoparticles to palladium nanoparticles was 2:1. The forward peak current density (hereinafter “I_{f}”), the backward peak current density (hereinafter “I_{b}”), the ratio of the I_{f} to the I_{b} (hereinafter “I_{f}/I_{b} ratio”), the forward onset potential (hereinafter “E_{f}”), and backward onset potential (hereinafter “E_{b}”) of the DMFCs with the four CNTs-g-PCA-M electrocatalysts was measured, as shown in TABLE 1 below.

| | Forward Sweep | | Backward Sweep | | |
|---|---|---|---|---|---|
| | E_{f} | I_{f} | E_{b} | I_{b} | I_{f}/I_{b} |
| Electrode | (V) | (mA/mg) | (V) | (mA/mg) | Ratio |
| Al/MWCNTs-g-PCA-Pd | 0.98 | 18.0 | 0.85 | 17.1 | 1.05 |
| Al/MWCNTs-g-PCA-Pt | 0.84 | 22.0 | 0.98 | 21.2 | 1.04 |
| Al/MWCNTs-g-PCA- | 0.50 | 62 | 0.61 | 41.3 | 1.50 |
| Pt&Pd (1:1) | | | | | |
| Al/MWCNTs-g-PCA- | 0.21 | 128 | 0.48 | 79.0 | 1.62 |
| Pt&Pd (2:1) | | | | | |

The magnitude of the I_{f} of the DMFCs is directly proportional to the amount of methanol oxidized at the electrode that also forms adsorbed carbonaceous deposits on platinum, as shown in electrochemical EQ. 1. As shown in TABLE 1, the I_{f} of the DMFC with the MWCNTs-g-PCA-Pt&Pd (2:1) electrocatalyst is more than twice that of the DMFC with the MWCNTs-g-PCA-Pt&Pd (1:1) electrocatalyst and about six times that of the DMFCs with the MWCNTs-g-PCA-Pd and MWCNTs-g-PCA-Pt electrocatalysts. As such, the amount of methanol oxidized by the MWCNTs-g-PCA-Pt&Pd (2:1) electrocatalyst is the most of any of the tested catalysts.

The magnitude of the I_{b} of the DMFCs is attributed to the oxidation of the adsorbed carbonaceous deposits on platinum, as shown in electrochemical EQ. 2. As shown in TABLE 1, the I_{b} of the DMFC with the MWCNTs-g-PCA-Pt&Pd (2:1) electrocatalyst is almost twice that of the DMFC with the MWCNTs-g-PCA-Pt&Pd (1:1) electrocatalyst and about four times that of the DMFCs with the MWCNTs-g-PCA-Pd and MWCNTs-g-PCA-Pt electrocatalysts. As such, the amount of carbon monoxide absorbed on the platinum nanoparticles that are oxidized in the CNTs-g-PCA-Pt&Pd (2:1) electrocatalyst is the most of any of the tested catalysts, resulting in a more efficient electrocatalyst.

The I_{f}/I_{b} ratio reflects the fraction of the electrocatalytic surface that does not absorb carbon monoxide. In other words, the I_{f}/I_{b} ratio can be used to describe the tolerance of platinum electrocatalysts to carbon monoxide and other carbonaceous species. As shown in TABLE 1, the I_{f}/I_{b} ratio of the DMFC with the CNTs-g-PCA-Pt&Pd (2:1) electrocatalyst is about 10% higher than that of the DMFC with the CNTs-g-PCA-Pt&Pd (1:1) electrocatalyst and more than 50% higher than that of the DMFCs with the CNTs-g-PCA-Pd and CNTs-g-PCA-Pt electrocatalysts. As such, CNTs-g-PCA-Pt&Pd electrocatalysts generate a more complete oxidation of methanol. This result can be due to the presence of the palladium nanoparticles in the CNTs-g-PCA-Pt&Pd electrocatalysts, where palladium can help oxidize water, which leads to the oxidization of the carbon monoxide bonded to platinum to be released as carbon dioxide.

The onset potential of the DMFCs can be an indicator of the electrochemical activity for methanol oxidation. As shown in TABLE 1, the E_{f} of the DMFC with the CNTs-g-PCA-Pt&Pd (2:1) electrocatalyst is less than 50% of that of the DMFC with the CNTs-g-PCA-Pt&Pd (1:1) electrocatalyst and less than 25% of the DMFCs with the CNTs-g-PCA-Pd and CNTs-g-PCA-Pt electrocatalysts. The E_{b} of the DMFC with the CNTs-g-PCA-Pt&Pd (2:1) electrocatalyst is about 25% less than that of the DMFC with the CNTs-g-PCA-Pt&Pd (1:1) electrocatalyst and about half of that of the DMFCs with the CNTs-g-PCA-Pd and CNTs-g-PCA-Pt electrocatalysts. As such, CNTs-g-PCA-Pt&Pd electrocatalysts generate a more complete oxidation of methanol to carbon dioxide at much lower onset potentials due to the presence of palladium nanoparticles, the fine dispersion of the nanoparticles in the functionalized groups of the MWCNTs, and the improved platinum interaction through the surface of the carboxylic groups of the polymerized MWCNTs.

It is to be understood that the disclosed implementations are not limited to the particular processes, devices, and/or apparatus described which may, of course, vary. It is also to be understood that the terminology used herein is for the purpose of describing particular embodiments only, and is not intended to be limiting. As used in this application, the singular forms “a,” “an,” and “the” include plural referents unless the content clearly indicates otherwise.

Reference in the specification to “one implementation” or “an implementation” means that a particular feature, structure, characteristic, or function described in connection with the implementation is included in at least one implementation herein. The appearances of the phrase “in some implementations” in the specification do not necessarily all refer to the same implementation.

Accordingly, other embodiments and/or implementations are within the scope of this application.

What is claimed is:

1. A method for forming a fuel cell electrode, comprising:
synthesizing carbon nanotubes grafted with poly(citric acid) encapsulating platinum group metal nanoparticles; and
electrospray depositing the carbon nanotubes grafted with poly(citric acid) encapsulating platinum group metal nanoparticles on an electrode of a fuel cell.

2. The method of claim 1, wherein synthesizing the carbon nanotubes grafted with poly(citric acid) encapsulating platinum group metal nanoparticles comprises:
oxidizing carbon nanotubes;
mixing the oxidized carbon nanotubes and monohydrated citric acid to synthesize carbon nanotubes grafted with poly(citric acid); and
mixing the carbon nanotubes grafted with poly(citric acid) with one or more sources of platinum group metal ions to synthesize the carbon nanotubes grafted with poly(citric acid) encapsulating platinum group metal nanoparticles.

3. The method of claim 2, wherein oxidizing the carbon nanotubes comprises mixing the carbon nanotubes, nitric acid, and sulfuric acid to oxidize the carbon nanotubes in a first mixture.

4. The method of claim 3, wherein the ratio of the nitric acid to the sulfuric acid in the first mixture is 1 to 3.

5. The method of claim 2, wherein mixing the carbon nanotubes grafted with poly(citric acid) with the one or more sources of platinum group metal ions to synthesize the carbon nanotubes grafted with poly(citric acid) encapsulating platinum group metal nanoparticles comprises mixing the carbon nanotubes grafted with poly(citric acid) with one or more of chloroplatinic acid, platinum oxide, platinum chloride, and platinum acetylacetonate to synthesize carbon nanotubes grafted with poly(citric acid) encapsulating platinum nanoparticles.

6. The method of claim 2, wherein mixing the carbon nanotubes grafted with poly(citric acid) with the one or more sources of platinum group metal ions to synthesize the carbon nanotubes grafted with poly(citric acid) encapsulating platinum group metal nanoparticles comprises mixing the carbon nanotubes grafted with poly(citric acid) with one or more of palladium chloride, palladium nitrate, palladium sulfate, and palladium acetylacetonate to synthesize carbon nanotubes grafted with poly(citric acid) encapsulating palladium nanoparticles.

7. The method of claim 2, wherein mixing the carbon nanotubes grafted with poly(citric acid) with the one or more sources of platinum group metal ions to synthesize the carbon nanotubes grafted with poly(citric acid) encapsulating platinum group metal nanoparticles comprises mixing the carbon nanotubes grafted with poly(citric acid) with one or more of chloroplatinic acid, platinum oxide, platinum chloride, and platinum acetylacetonate and one or more of palladium chloride, palladium nitrate, palladium sulfate, and palladium acetylacetonate to synthesize carbon nanotubes grafted with poly(citric acid) encapsulating platinum and palladium nanoparticles.

8. The method of claim 1, wherein synthesizing the carbon nanotubes grafted with poly(citric acid) encapsulating platinum group metal nanoparticles comprises synthesizing multi-walled carbon nanotubes grafted with poly(citric acid) encapsulating platinum group metal nanoparticles.

9. The method of claim 1, wherein synthesizing the carbon nanotubes grafted with poly(citric acid) encapsulating platinum group metal nanoparticles comprises synthesizing carbon nanotubes grafted with poly(citric acid) encapsulating platinum nanoparticles.

10. The method of claim 1, wherein synthesizing the carbon nanotubes grafted with poly(citric acid) encapsulating platinum group metal nanoparticles comprises synthesizing carbon nanotubes grafted with poly(citric acid) encapsulating palladium nanoparticles.

11. The method of claim 1, wherein synthesizing the carbon nanotubes grafted with poly(citric acid) encapsulating platinum group metal nanoparticles comprises synthesizing carbon nanotubes grafted with poly(citric acid) encapsulating platinum and palladium nanoparticles.

12. The method of claim 11, wherein the ratio of platinum nanoparticles to palladium nanoparticles in the carbon nanotubes grafted with poly(citric acid) encapsulating platinum and palladium nanoparticles is 2:1.

13. The method of claim 1, wherein electrospray depositing the carbon nanotubes grafted with poly(citric acid) encapsulating platinum group metal nanoparticles on the electrode of the fuel cell comprises electrospray depositing the carbon nanotubes grafted with poly(citric acid) encapsulating platinum group metal nanoparticles on an electrode of a direct methanol fuel cell.

14. The method of claim 1, wherein electrospray depositing the carbon nanotubes grafted with poly(citric acid) encapsulating platinum group metal nanoparticles on the electrode of the fuel cell comprises electrospray depositing the carbon nanotubes grafted with poly(citric acid) encapsulating platinum group metal nanoparticles on an anode of the fuel cell.

15. The method of claim 1, wherein electrospray depositing the carbon nanotubes grafted with poly(citric acid) encapsulating platinum group metal nanoparticles on the electrode of the fuel cell comprises electrospray depositing the carbon nanotubes grafted with poly(citric acid) encapsulating platinum group metal nanoparticles on the electrode of the fuel cell at a flow rate greater than or equal to 600 μL/min.

16. The method of claim 1, wherein electrospray depositing the carbon nanotubes grafted with poly(citric acid) encapsulating platinum group metal nanoparticles on the electrode of the fuel cell comprises electrospray depositing the carbon nanotubes grafted with poly(citric acid) encapsulating platinum group metal nanoparticles on the electrode of the fuel cell at an electric field potential greater than or equal to 18 kV.

17. The method of claim 1, wherein electrospray depositing the carbon nanotubes grafted with poly(citric acid) encapsulating platinum group metal nanoparticles on the electrode of the fuel cell comprises electrospray depositing the carbon nanotubes grafted with poly(citric acid) encapsulating platinum group metal nanoparticles on the electrode of the fuel cell in an interlaced manner.

18. A method for forming a direct methanol fuel cell anode, comprising:
oxidizing carbon nanotubes;
mixing the oxidized carbon nanotubes and monohydrated citric acid to synthesize carbon nanotubes grafted with poly(citric acid);
mixing the carbon nanotubes grafted with poly(citric acid) with chloroplatinic acid, palladium chloride, and sodium borohydride to synthesize carbon nanotubes grafted with poly(citric acid) encapsulating platinum and palladium nanoparticles, wherein the ratio of platinum nanoparticles to palladium nanoparticles is greater than or equal to 2:1; and
electrospray depositing the carbon nanotubes grafted with poly(citric acid) encapsulating platinum and palladium nanoparticles on an anode of the direct methanol fuel cell.

19. The method of claim 18, wherein the amount of chloroplatinic acid mixed with the carbon nanotubes grafted with poly(citric acid) is twice that of the palladium chloride.

20. A fuel cell electrode formed by a process comprising the steps of:
synthesizing carbon nanotubes grafted with poly(citric acid) encapsulating platinum group metal nanoparticles; and
electrospray depositing the carbon nanotubes grafted with poly(citric acid) encapsulating platinum group metal nanoparticles on an electrode of a fuel cell.
